(19) United States
(12) Patent Application Publication
(10) Pub. No.: US 2013/0137455 A1
(43) Pub. Date: May 30, 2013

(54) WIRELESS ENERGY TRANSFER SYSTEM

(71) Applicant: Sony Corporation, Tokyo (JP)

(72) Inventors: Jing Jing Xia, Singapore (SG); Wei Beng Ng, Singapore (SG); Hisashi Masuda, Singapore (SG)

(73) Assignee: Sony Corporation, Tokyo (JP)

(21) Appl. No.: 13/674,301

(22) Filed: Nov. 12, 2012

(30) Foreign Application Priority Data
Nov. 28, 2011 (SG) 201108853-1

(51) Int. Cl. H02J 17/00

(52) U.S. Cl. CPC H02J 17/00
USPC 455/456.1; 307/104

(57) ABSTRACT

A wireless energy transfer system comprising: a transmitter configured to beam scan RF radiation across a plurality of sectors at a first frequency, a receiver storing energy from the RF radiation, and sending acknowledgements at a second frequency, the first frequency being significantly different from the second frequency, and a controller configured to direct wireless energy transfer from the transmitter substantially at the receiver based on the acknowledgements.

### FIELD

The present invention relates to a wireless energy transfer system.

### BACKGROUND

With mobile electronic devices becoming more popular, ease and flexibility of charging the mobile device's battery is of increasing importance. Typically most prior art devices use a mains connected converter which is hard wire connected to the mobile device to provide a low voltage DC supply for charging.

An alternative to wired charging is wireless charging. Prior art examples of wireless energy transfer include induction, resonant coupling, electromagnetic radiation and laser. Induction may only be useful where the device is very close, such as wireless dock charging for electric toothbrushes, or a transformer. At mid distances resonant coupling is used, such as in some RFID and smart cards. Because the efficiency reduces dramatically with distance, for larger distances a high degree of directionality is required. Longer distance options include EM radiation and laser. However such methods maybe sensitive to the device orientation. Thus the user may have to keep the device stationary and perpendicular to the flux to maintain the power transfer.

For mobile electronic devices, it may be more convenient if the user did not have to dock the device for charging. For example it may be desirable if the device was able to charge when the user was simply in the same room as the charging station, (perhaps with the device in his or her pocket), similar to WiFi hotspots. In this scenario induction and laser are inappropriate, and EM radiation may be more desirable.

Thus for EM radiation it is necessary to focus the radiation on the device, and therefore to track the device's location. One technical challenge may be how to locate a receiver accurately at very low power consumption at the receiver. Prior art solutions such as RFID may prove difficult because:

(a). A generic RFID module at UHF band, if mounted in the transmitter and receiver, may not allow for beam scanning and the omni-directional radiation is very inefficient.

(b). Because of the ultra low power level, it may be difficult to resolve between the signal from the TX, acknowledgement from the RX, any reflections and other interference, to allow for accurate 3D location estimation.

Prior art attempts at wireless energy transfer include U.S. Pat. Nos. 6,856,291; 7,057,514; 7,383,064 and 7,639,994, and Japanese Patent Publication number 08-103039. However these do not provide suitable solutions to the problem mentioned.

### SUMMARY OF THE INVENTION

In general terms, the invention relates to a wireless energy transfer system that is capable of:

1. Transmitting RF energy to a single or multiple specific directions rather than omni-directionally or a front-side,

2. Wirelessly charging mobile electronic devices which consume less than a dozen millwatts, yet avoiding unnecessary radiation to humans,

3. accurately detecting the 3D location of a mobile electronic device that needs energy transfer, and/or

4. Tracking the mobile electronic device whilst in motion.

The detecting and tracking may done by a transmitter (Tx) or base station, using beam scanning across the volume/area of coverage, which is divided into sectors. The beam scanning is done at 2.45 GHz. If a receiver (Rx) or mobile electronic device receives the beam scan it sends an acknowledgement at 860 MHz. The strongest acknowledgement indicates to the TX which sector the RX is in, after which energy transfer is focussed towards that sector.

In a first specific aspect there is provided a wireless energy transfer system comprising: a transmitter configured to beam scan RF radiation across a plurality of sectors at a first frequency, a receiver storing energy from the RF radiation, and sending acknowledgements at a second frequency, the first frequency being significantly different from the second frequency, and a controller configured to direct wireless energy transfer from the transmitter substantially at the receiver based on the acknowledgements.
The first frequency may be in an ISM band
The ISM band may be substantially located about 2.45 GHz or 5.80 GHz.
The second frequency may be in an RFID band.
The RFID band is substantially located about 866-869 MHz or 310 to 320 MHz.
The transmitter comprises a steerable phased array antenna.
The receiver may comprise a first omni-directional antenna to receive the first frequency and a second omni-directional antenna to send on the second frequency.
The receiver may further comprise a battery or super capacitor configured to store the energy from the first omni-directional antenna.
The receiver may further comprise a function generator configured to generate very low frequency pulses from the battery or super capacitor and a voltage controlled oscillator to generate the second frequency from the very low frequency pulses.
In a second specific aspect there is provided a method of locating a receiver relative to a transmitter comprising: scanning a beam of RF radiation over a plurality of sectors; receiving an acknowledgement from one or more sectors; and determining the location of the receiver based on which sector had the strongest acknowledgement.
In a third specific aspect there is provided a method of wireless energy transfer comprising: locating a receiver according to the preceding paragraph; and focussing RF radiation at the receiver's location
The method may further comprise tracking any change in the receiver's location.
The acknowledgement may be at a substantially lower frequency than the beam of RF radiation.

### BRIEF DESCRIPTION OF THE DRAWINGS

One or more example embodiments of the invention will now be described, with reference to the following figures, in which:

FIG. 1 is a block diagram of the overall RF based wireless energy transfer system with receiver searching and tracking functions,

FIG. 2 is a block diagram of the proposed circuits for RX acknowledgement,

FIG. 3 is a schematic diagram of the sensing circuit in the receiver,

FIG. 4 is a schematic diagram of two possible constructions of small profile compact RX,

FIG. 5 is a block diagram of the RFID detection circuits at the TX,

FIG. 6 is operations of different blocks in FIG. 5,

FIG. 7 is a calculated radiation pattern of proposed system with single radiation beam, and

FIG. 8 is a calculated radiation pattern of proposed system with multiple radiation beams.

### DETAILED DESCRIPTION

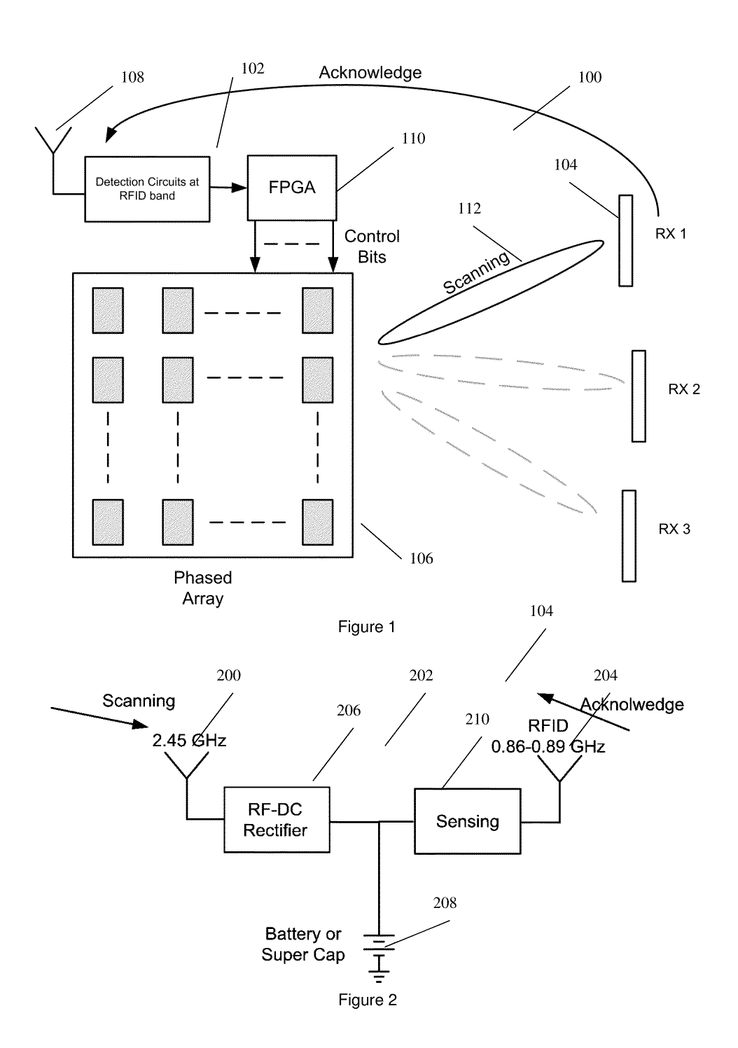

The system 100 is shown in FIG. 1 for wireless energy transfer between a base station 102 and a mobile electronic device 104. The base station 102 includes a 2.4 GHz steerable antenna 106 for transmitting and a 860 MHz antenna 108 for receiving acknowledgements. A Field Programmable Gate Array (FPGA) 110 acts as a controller. The FPGA 110 controls the steerable antenna 106 to send focused burst of RF radiation scanning across a range of sectors 112 searching for any devices 104. Based on any acknowledgements received, the FPGA 110 will make a determination on the location of any identified devices 104. The steerable antenna 106 then focuses continuous RF radiation towards the location to transfer energy to the device 104. The location is tracked and if the deice 104 moves to another sector, the location is updated.

The steerable antenna 106 is a phased array with M×N elements. It transmits RF energy at 2.45 GHz and has a range of a couple of meters. The coverage area is divided into sectors which may be 1D or 2D. For example if the sectors are 1D, then each sector is defined by a horizontal angle from a reference. In FIG. 1 the coverage area is over approximately a 180° angle and there are 7 sectors. The dimensions and configuration of sectors may be determined to suit the application.

The mobile electronic device 104 may be a mobile phone, digital camera, portable media player, radio, LED lighting devices or the like. Typically the device 102 will be low power consumption, for example less than 1W.

The device 104 is shown in more detail in FIG. 2. Generally the device 104 includes a 2.4 GHz receiving antenna 200, a circuit or IC 202 and a 860 MHz transmitting antenna 204. The circuit 202 operates when a pulse is received on antenna 200, and sends an acknowledgement signal on the antenna 204. Once the device 104 has been located, IC 202 stores the energy transferred to the antenna 200 for later use by the device 104 during normal operation.

Both the receiving antenna 200 and transmitting antenna 204 are omni directional. For example FIG. 4 shows two possible antenna configurations. Either a folded dipole or normal dipole are shown, although the particular antenna may depending on the actual layout of electronics it is attached to.

The IC 202 may be an ASIC (application specific integrated circuits) design (such as a low cost CMOS process) which is ultra low power consumption. It may include an RF-DC rectifier 206, a battery or super capacitor 208 and an acknowledgement circuit 210. The RF-DC rectifier 206 converts the RF energy and rectifies it into DC, which is stored in the battery or a super capacitor 208.

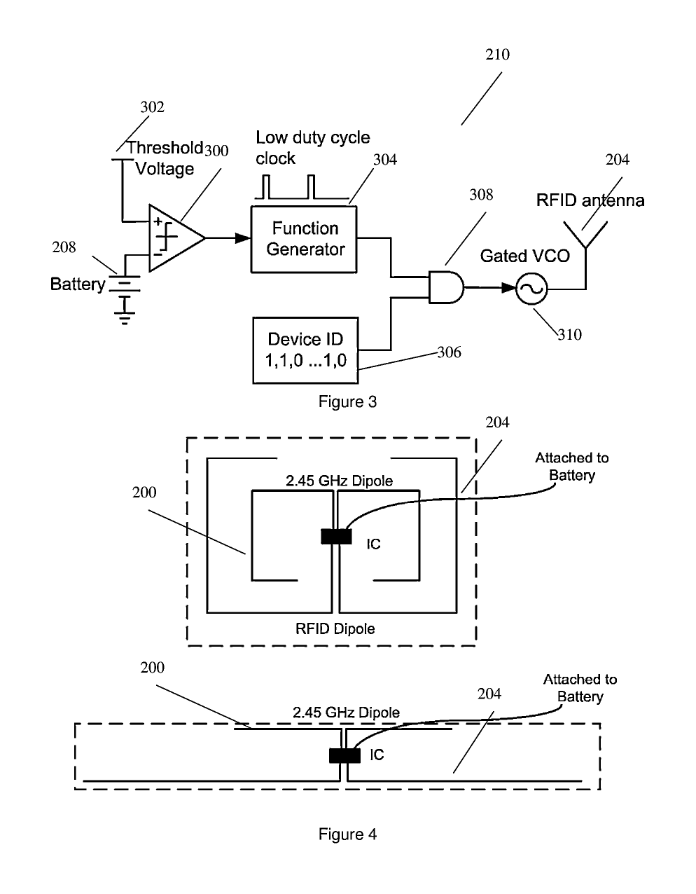

The acknowledgement circuit 210 is shown in more detail in FIG. 3. A comparator 300 determines whether the battery 208 needs charging by comparing its voltage with an external voltage reference 302. There is no acknowledgement sent to the base station 102 if the battery voltage is above the threshold voltage.

If the battery voltage is below the threshold 302, the comparator 300 enables a function generator 304. The enabled function generator 304 generates pulses at very low frequency (˜kHz or lower). Normally data pulses have a duty cycle of 50%. To save energy as much as possible, its duty cycle may be reduced to 1% or even lower. However, its pulse width may be reasonably wide, and may be limited by the available bandwidth in RFID. If the antennas in FIG. 5 have a 3 MHz available bandwidth, the on-period may be no smaller than 6.7 us.

Each receiver has a unique ID 306 and this data is multiplied 308 with the low frequency clock output from the function generator 304. An oscillator 310 will be powered on and tuned by the coded pulses from the multiplier 308. The oscillator 310 is a gated voltage controlled oscillator with a 867.5 MHz central frequency. By using ultra-low duty cycle pulse trains, the overall power consumption of the oscillator 310 may be minimized and will be only a fraction of the received power. The oscillator 310 output is transmitted by the transmitting antenna 204.

The receiving antenna 108 is shown in more detail in FIG. 5. The receiving antenna 108 may an omni directional antenna tuned to 0.86-0.89 MHz, 310-320 MHz, or other RFID band. The antenna 108 output is amplified by a low noise amplifier 500 followed by an envelope detector 502. This removes the carrier frequency (867.5 MHz for example) and leaves only a baseband waveform. The baseband waveform is demodulated 504 to determine the device ID, which is stored in the FPGA 110. The baseband waveform is also integrated 506 and sampled by an ADC 508. The digital signal is provided to the FPGA 110. A switch 510 is closed to reset the voltage on the integrator after the scan moves to the next sector.

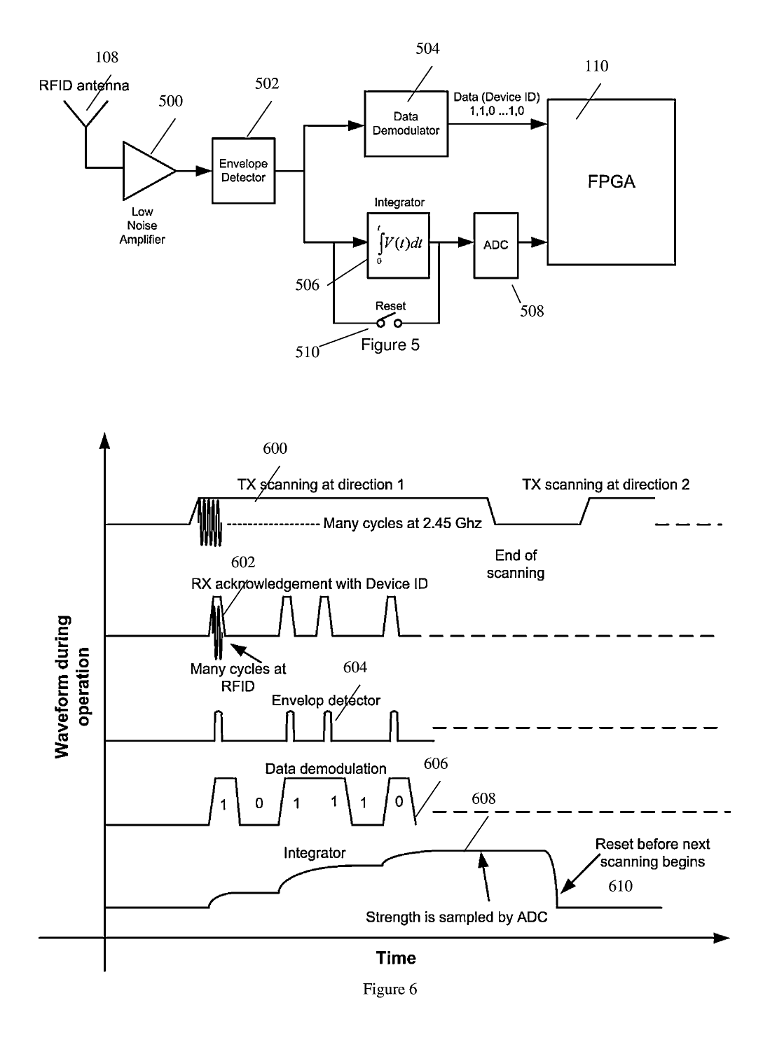

Operation of the FPGA 110 is shown by the various waveforms in FIG. 6. When the steerable antenna 106 starts scanning 600, the receiving antenna 108 is enabled awaiting for responses 602 from the device 104. Since two separate frequencies are used, they are working independently and there is no talk-and-listen period required. The envelope 604 of the received acknowledgement 602 is demodulated to data 606, so the FGPA 100 recognizes the device 104. This envelope is also integrated 608 to measure the feedback signal strength. A reset signal 610 will be given at the end before measuring the feedback strength. After one sector, the steerable antenna 106 moves to the next sector and starts scanning again.

The system 100 will operate in at least two modes:

1. Searching for receivers

The FGPA 110 scans and stores the sampled peak voltage of the feedback. It then compares all the sectors and the highest voltage peak is the estimate of the device 104 location.

2. Charging and tracking of receivers

In the course of charging, the device 104 keeps acknowledging at very low duty cycles. If the battery is fully charged, no acknowledgement will be sent. The device 104 stops charging. The FGPA 110 also stores the peak detected energy. If there is a big variation in peak detected energy, the steerable antenna 106 enters mode 1 and starts scanning again.

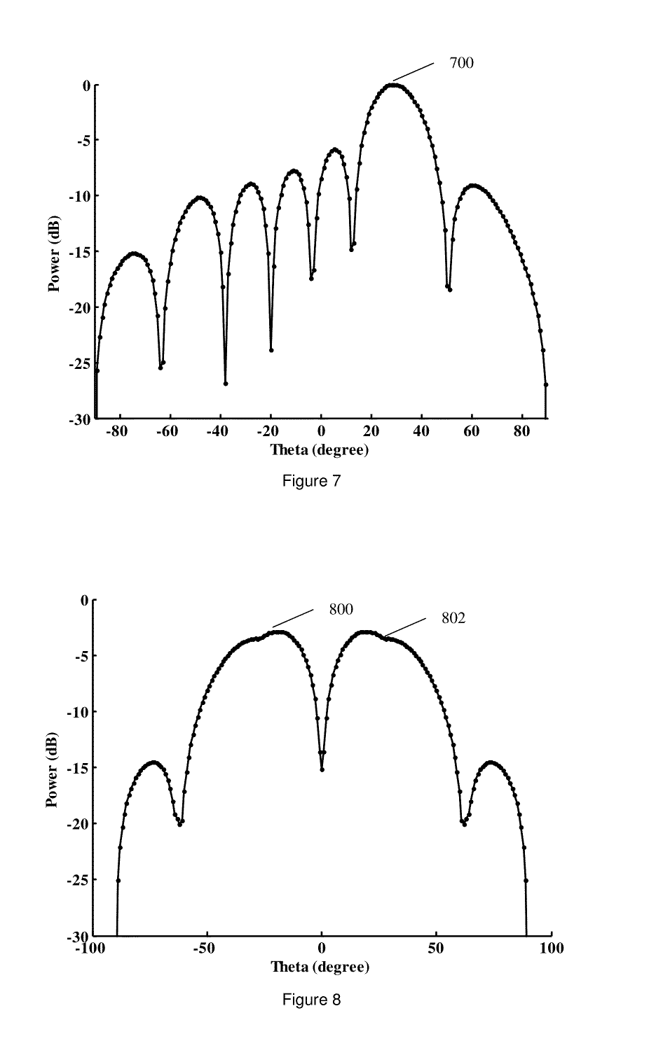

In most applications, the steerable antenna 106 will focus an RF beam at a single direction. However, it is also possible to configure the steerable antenna 106 to send focus beams. With 8 antennas in a row, the radiation pattern of transmitting at +30 degrees 700 is plotted in FIG. 7. If the steerable antenna 106 was controlled to focus two beams instead of one, the feed is reconfigured with the 8 elements split into 2 sub-arrays, each consisting of 4 elements. Radiation pattern of two sub-arrays delivering power to +30 802 and −30 degrees 800 are plotted in FIG. 8. The penalty of doing this may be wider beam width, since less elements are used, and may be reduced power by a factor of 2.

The advantages of using two widely separated frequencies transmit and receive frequencies rather than one single frequency may include:

1. Less or no interference between RF transmit and receive frequency.

2. The ability to conduct beam scanning allowing higher efficiency of energy transfer.

3. Low power consumption at the device 104.

4. Smaller device 104 size.

5. Because the acknowledgement signal is such low power, this system allows relatively accurate detection.

6. Since no talk and listen period is required, the acquisition time is very fast and the system can dynamically track device movement with minimal delay.

While example embodiments of the invention have been described in detail, many variations are possible within the scope of the invention as claimed as will be clear to a skilled reader.

1. A wireless energy transfer system comprising:
a transmitter configured to beam scan RF radiation across a plurality of sectors at a first frequency;
a receiver storing energy from the RF radiation, and sending acknowledgements at a second frequency, the first frequency being significantly different from the second frequency; and
a controller configured to direct wireless energy transfer from the transmitter substantially at the receiver based on the acknowledgements.

2. The system in claim 1, wherein the first frequency is in an ISM band.

3. The system in claim 2, wherein the ISM band is substantially located about 2.45 GHz or 5.80 GHz.

4. The system in claim 1, wherein the second frequency is in an RFID band.

5. The system in claim 4, wherein the RFID band is substantially located about 866-869 MHz or 310 to 320 MHz.

6. The system in claim 1, wherein the transmitter comprises a steerable phased array antenna.

7. The system in claim 1, wherein the receiver comprises a first omnidirectional antenna to receive the first frequency and a second omnidirectional antenna to send on the second frequency.

8. The system in claim 7, wherein the receiver further comprises a battery or super capacitor configured to store the energy from the first omnidirectional antenna.

9. The system in claim 8, wherein the receiver further comprises a function generator configured to generate very low frequency pulses from the battery or super capacitor and a voltage controlled oscillator to generate the second frequency from the very low frequency pulses.

10. A method of locating a receiver relative to a transmitter comprising:
scanning a beam of RF radiation over a plurality of sectors;
receiving an acknowledgement from one or more sectors; and
determining the location of the receiver based on which sector had the strongest acknowledgement.

11. A method of wireless energy transfer comprising:
locating a receiver according to claim 8; and
focussing RF radiation at the receiver's location,

12. The method of claim 11, further comprising tracking any change in the receiver's location.

13. The method of claim 12, wherein the acknowledgement is at a substantially lower frequency than the RF radiation.
